(19) United States
(12) Patent Application Publication
(10) Pub. No.: US 2014/0059472 A1
(43) Pub. Date: Feb. 27, 2014

(54) METHODS AND SYSTEMS FOR CONTROLLING ELECTRONIC DEVICES

(71) Applicant: Recon Instruments Inc., Vancouver (CA)

(72) Inventors: Gil ZHAIEK, Burnaby (CA); Christopher Robert Tolliday, Vancouver (CA)

(73) Assignee: Recon Instruments Inc., Vancouver (CA)

(21) Appl. No.: 13/974,968

(22) Filed: Aug. 23, 2013

Related U.S. Application Data
(60) Provisional application No. 61/693,097, filed on Aug. 24, 2012.

(51) Int. Cl. G06F 3/0484

(52) U.S. Cl. CPC G06F 3/04842
USPC 715/773

(57) ABSTRACT

A method includes, on a display of an electronic device, displaying a key layout, the key layout comprising a plurality of rows of keys and a plurality of columns of keys, displaying an indication of an active position at a first location for selecting one of the keys, detecting a directional input, and in response to the directional input, adjusting the key layout while maintaining display of the indication of the active position at the first location.

### CROSS-REFERENCE TO RELATED APPLICATION

This application claims the benefit of priority under 35 U.S.C. §119 of U.S. Provisional Patent Application No. 61/693,097 filed Aug. 24, 2012 and entitled METHODS AND SYSTEMS FOR CONTROLLING ELECTRONIC DEVICES, which is incorporated herein by reference in its entirety.

### FIELD OF TECHNOLOGY

The present disclosure relates to controlling electronic devices. Certain embodiments provide improved methods and systems for inputting text on electronic devices.

### BACKGROUND

Various prior art systems exist for providing skiers, snowboarders, bikers and athletes taking part in other sports with information, including information regarding their performance. Many current solutions include electronic devices such as portable GPS devices, performance measurement units, wristwatches, mobile phones, and tablet computers, among others, that require the user to stop, and possibly remove gloves, in order to interact with the device and look at the information. This may create discomfort, waste time, cause delays and may furthermore be prone to inaccurate measurements. Even if the user is not required to stop, such systems may be difficult to see and/or to interact with while the user is performing their desired activity (e.g. skiing or snowboarding).

The output displays of current technologies are often inconvenient to access and lack user-friendly interfaces, and users may need to remove their gloves or mittens in order to control the devices.

It may be difficult and/or inconvenient for users to control electronic devices, particularly when the user is wearing gloves or mittens. Also, for a device which is located in a pocket, backpack or under the clothing of the user, interaction with the device while engaging in athletic or other activity may not be practical.

Furthermore, for activities which require both of the user's hands (e.g. skiing, cycling (including motorcycling), piloting all-terrain vehicles, and snowmobiling), interaction with a performance monitoring or other electronic device which requires the user to press buttons or manipulate other controls may be unsafe or impossible.

Some electronic devices include a virtual keyboard for entry of text or other information. A virtual keyboard is a keyboard that is displayed on a display of an electronic device and allows a user to enter characters or symbols using an input device such as a mouse, a keyboard, or a touch-sensitive pad or display. Entering text using a virtual keyboard that requires use of one or both hands may be cumbersome when engaged in physical activity. Also, it may be difficult to locate and select individual keys of a virtual keyboard, when the user's attention is focused elsewhere during sports or other activities.

Patents and published applications relating to controlling electronic devices with head-mounted information systems include the following:

U.S. Pat. No. 6,184,847 to Fateh et al;

U.S. Pat. No. 6,396,497 to Riechlen;

U.S. Pat. No. 7,580,540 to Zurek et al.;

United States Patent Application Publication No. 2002/0021407 to Elliott;

United States Patent Application Publication No. 2005/0156817 to Iba; and,

United States Patent Application Publication No. 2008/0208396 to Cairola et al.

Improvements in electronic devices with virtual keyboards, including devices with head-mounted information systems, are desirable.

The foregoing examples of the related art and limitations related thereto are intended to be illustrative and not exclusive. Other limitations of the related art will become apparent to those of skill in the art upon a reading of the specification and a study of the drawings.

### BRIEF DESCRIPTION OF THE DRAWINGS

Examples are illustrated with reference to the attached figures. It is intended that the examples and figures disclosed herein are to be considered illustrative rather than restrictive.

FIG. 1 is a front view of goggles incorporating a head-mounted information system according to an example;

FIG. 1A is a view from the goggles of FIG. 1;

FIG. 1B is a side view a helmet incorporating a head-mounted information system according to another example;

FIG. 1C is a front view of an underwater mask incorporating a head-mounted information system according to another example;

FIG. 1D is a front view of sunglasses incorporating a head-mounted information system according to another example;

FIG. 2 is a block diagram of an electronic system suitable for use with the head-mounted information systems of FIG. 1 to FIG. 1D;

FIG. 3 is a flowchart illustrating an example of a method of controlling a virtual key layout of an electronic device;

FIG. 3A is a flowchart illustrating another example of a method of controlling a virtual key layout of an electronic device;

FIG. 4 through FIG. 11 are views illustrating examples of controlling a virtual key layout of an electronic device in accordance with the methods of FIG. 3 and FIG. 3A.

### DETAILED DESCRIPTION

The following describes an electronic device and method including a method of, on a display of an electronic device, displaying a key layout, the key layout comprising a plurality of rows of keys and a plurality of columns of keys, displaying an indication of an active position at a first location for selecting one of the keys, detecting user navigation comprising a directional input, and in response to the directional input, adjusting the key layout while maintaining the active position at the first location.

Throughout the following description, specific details are set forth in order to provide a more thorough understanding to persons skilled in the art. However, well-known elements may not be shown or described in detail to avoid unnecessarily obscuring the disclosure. Accordingly, the description and drawings are to be regarded in an illustrative, rather than a restrictive, sense.

This disclosure relates generally to methods and systems for controlling an electronic device to enter text or other inputs to the electronic device. The methods and systems may interact with and/or be incorporated into any type of electronic device, including head-mounted information systems having sensing and display systems as well as optionally wireless connectivity to third party devices. Such head-mounted information systems may be implemented in a variety of head-mounted devices, such as, by way of non-limiting example: eyewear or eye protection devices (e.g. goggles, glasses, sunglasses, masks and/or the like), helmets (e.g. ski helmets, cycling (including motorcycling) helmets and/or the like) and/or hands-free mobile communication devices (e.g. hands free devices for mobile phones, tablet computers, PDAs, portable music players and/or the like). The head-mounted information system may provide the user with a heads-up display for displaying various parameters in real-time (such as, by way of non-limiting example: position, time, speed, vertical drop, airtime, etc.). The electronic components of the head-mounted information systems according to some examples include a sensor unit, a processor unit, a power unit, and a display unit. It is to be understood that the methods and systems described herein are also applicable to other types of electronic devices, such as, for example, desktop computers, laptop computers, tablet computers, handheld electronic devices, gaming consoles, set top boxes, and the like.

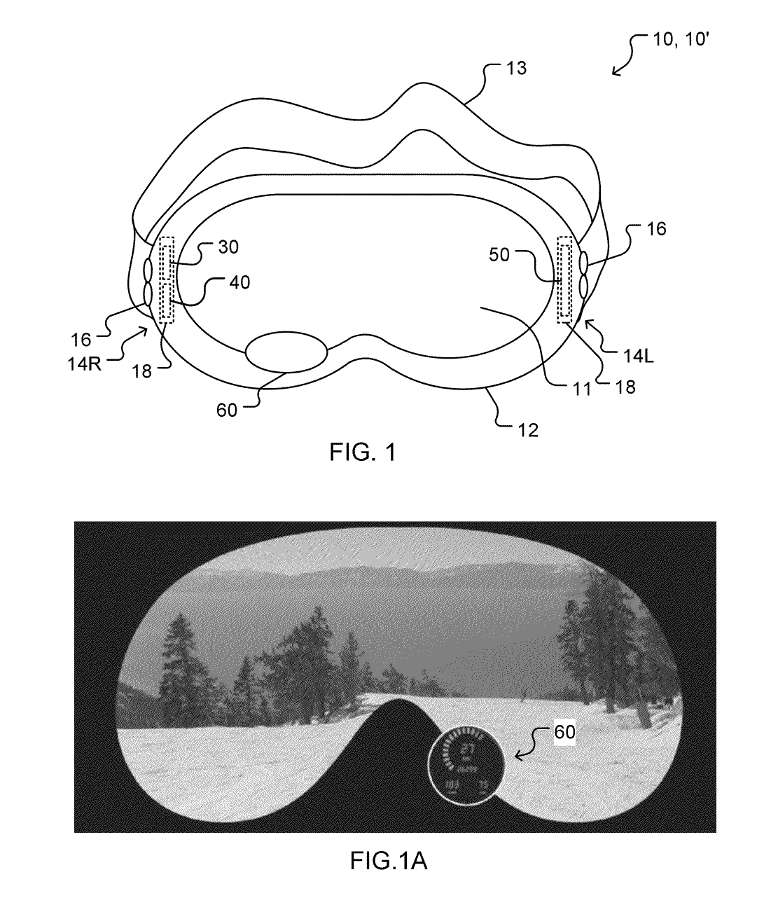

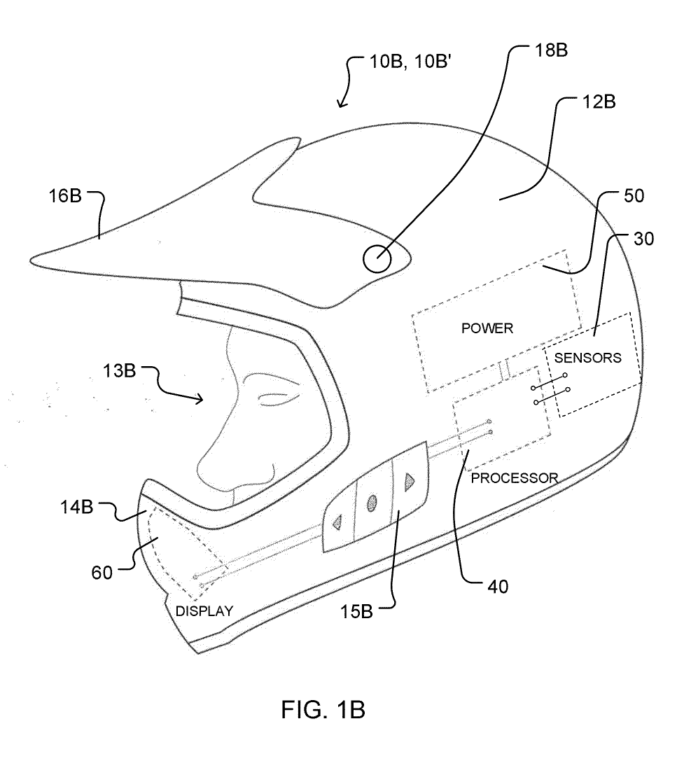

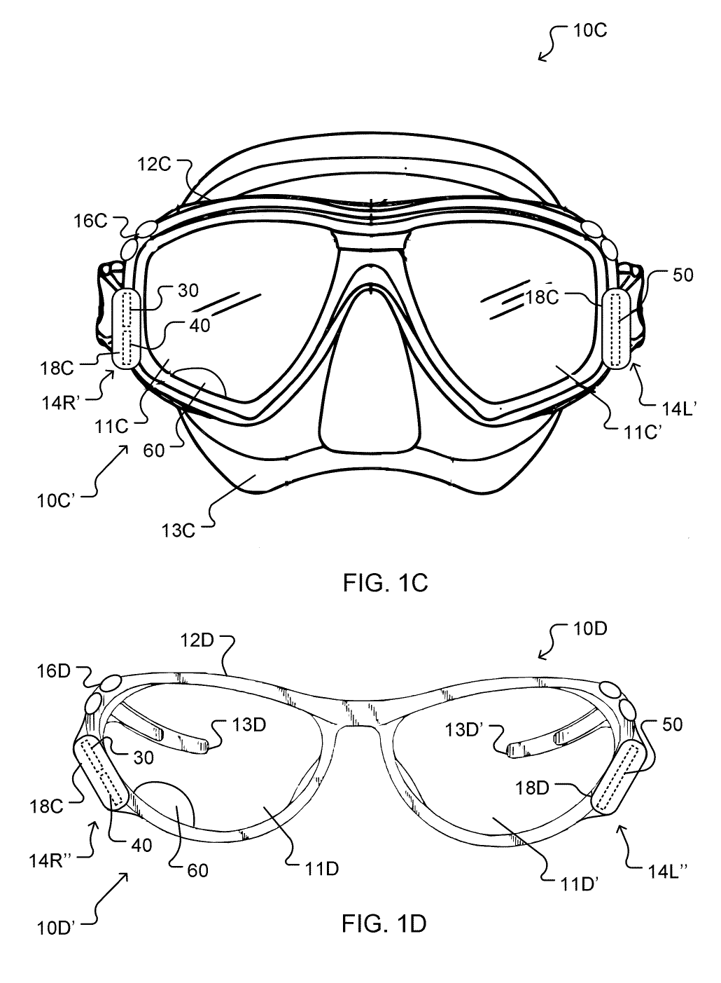

FIG. 1 shows an electronic device including a pair of goggles 10 incorporating a head-mounted information system 10′ according to a particular example. Goggles 10 may have the features of traditional goggles for a skier, snowboarder or cyclist, for example. Goggles 10 include processing circuitry configured to implement the methods according to examples as discussed below. Goggles 10 comprise a frame 12 that has an opening for receiving a lens assembly 11. Lens assembly 11 may comprise, for example, a cylindrical dual lens with a silicone seal, with an airtight space between the lenses to reduce fogging. Both lenses may have a 6-inch (15.25 cm) radial base curvature. The lenses may be coated with an anti-fog sealant. The lenses of the illustrated examples do not include ventilation holes, but may be ventilated in other examples. The lenses may be formed to define a recess in order to fit around a display unit 60 (discussed further below). Display unit 60 may be coupled to frame 12 so as to be positioned below a user's right eye when goggles 10 are worn, or at any other convenient location, as discussed further below.

Frame 12 may include a standard ventilation system (not shown) as known in the art. Suitable foam having a thickness of approximately 0.5 inches (1.25 cm) may be attached to the inner rim of frame 12 (i.e., the side which faces the user's face). Thinner foam membranes (several mm thick) may cover all vents on frame 12. Frame 12 may be held in place by a strap 13. Strap 13 may comprise a standard adjustable elastic head strap that may be worn over a helmet (or over a hat, or directly on a user's head) without sliding down or up.

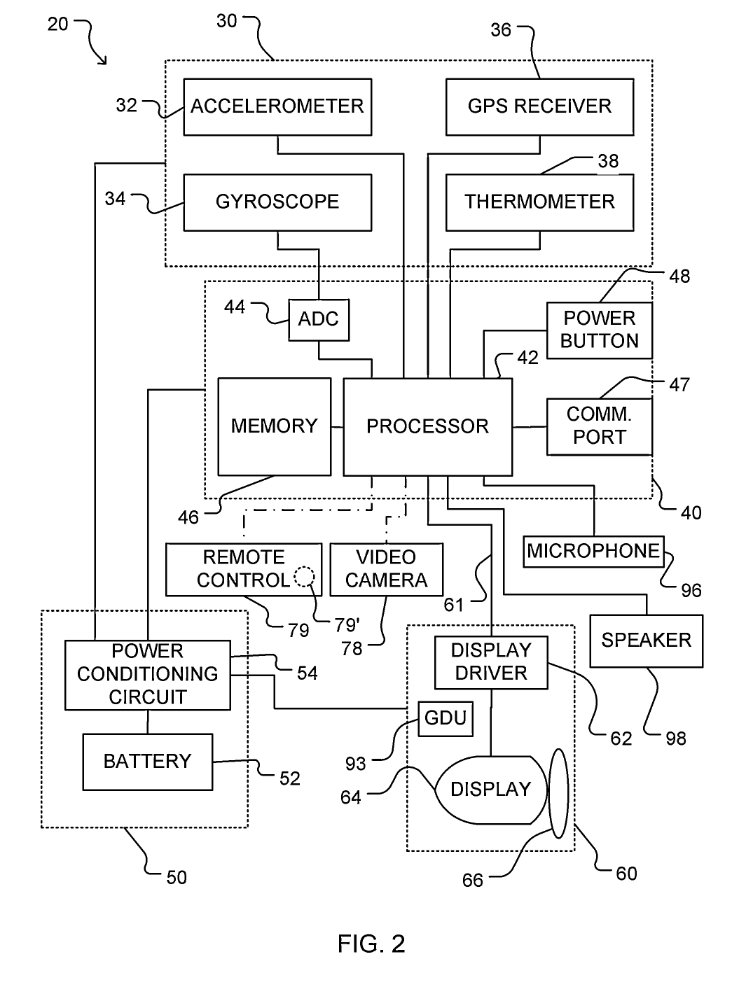

Frame 12 has enlarged portions referred to herein as “outriggers” 14 on the left and right sides thereof (individually numbered 14L and 14R, respectively). Outriggers 14 house portions of an electronic system 20 for a head-mounted information system 10′, as described below with reference to FIG. 2. In the illustrated example, electronic system 20 comprises a sensor unit 30 and a processor unit 40 housed within right outrigger 14R, and a power unit 50 housed within left outrigger. Electronic system 20 also comprises a display unit 60 positioned on frame 12 just below the right eye of a user wearing goggles 10 for providing information to the user. FIG. 1A shows an example view looking out goggles 10 which illustrates an example position of display unit 60. The locations of the components of electronic system 20 may be different in different examples. Display unit 60 may be positioned to provide for convenient viewing of display unit 60 without overly interfering with the user's sight lines through the remainder of lens assembly 11. In some examples, display unit 60 may be positioned at or near an edge of the user's field of vision. For example, display unit 60 could be positioned below the user's left eye in some examples, or may be positioned above or to the side of either eye. Similarly, sensors unit 30, processor unit 40 and power unit 50 may be positioned at any convenient locations within frame 12.

One or more user interface keys 16 may be provided on the sides of frame 12 in some examples (two user interface keys 16 are shown on each side of frame 12 in the illustrated example, but a different number of user interface keys could be provided). User interface keys 16 are configured such that they are easily reached by a user and may be tapped or otherwise manipulated while wearing gloves to interact with electronic system 20 of head-mounted information system 10′, as described below. In other examples, other forms of user-interface components could be provided in addition to or in the alternative to user interface keys 16. Non-limiting examples of such user interface components include: slidable or rotatable user interface components, joystick-type user interface components, optical (e.g. laser or LED-based) user interface components or the like.

In some examples, outriggers 14 may comprise flat plastic housings 18 embedded within frame 12 on either side of goggles 10 which house components of electronic system 20. Housings 18 protect components of electrical system 20 from mechanical stresses. Housings 18 may also be water-tight in some examples to protect components of electrical system 20 from moisture.

In other respects, goggles 10 may have the features of traditional goggles for a skier, snowboarder or cyclist, for example.

FIG. 1B shows a helmet 10B (e.g., a motorcycle helmet) incorporating a head-mounted information system 10B′ according to another example. Helmet 10B may have the features of traditional helmets for its particular application. For example, where helmet 10B is a motorcycle helmet, it may have the features of traditional motorcycle helmets or where helmet 10B is a skiing helmet, it may have the features of traditional skiing helmets. Helmet 10B includes processing circuitry configured to methods of controlling a virtual keyboard, as discussed below.

Helmet 10B of the illustrated example comprises an exterior shell 12B and one or more interior deformable layers (not explicitly enumerated) that define a cavity for accommodating the head of a user. Exterior shell 12B and/or the interior deformable layer(s) may function in manner similar to frame 12 of goggles 10 described herein and may be referred to in some instances as a frame 12B of helmet 10B. In particular examples, exterior shell 12B is relatively hard compared to the interior deformable layer(s). In some examples, exterior shell 12B and/or the interior deformable layer(s) 10 may themselves comprise multiple layers. In the illustrated example, helmet 10B comprises an optional face-protection element 14B that may be integrally formed with the remainder of helmet 10B or that may be detachably mounted to the remainder of helmet 10B. In the illustrated example, helmet 10B comprises optional eye-protection element (e.g. screen) 16B that may be rotated about pivot joints 18B into an open configuration (shown in FIG. 1B) where eye-protection element is away from face aperture 13B and the user's eyes and into a closed configuration (not shown) where eye-protection element is in front of face aperture 13B and the user's eyes. Eye-protection element 16B may be relatively transparent or may filter light in some respects (e.g. a color filter, a darkening filter, a polarizing filter or the like).

Helmet 10B houses the various components of an electronic system 20 for head-mounted information system 10B′, as described below with reference to FIG. 2. In the illustrated example, electronic system 20 comprises a sensor unit 30, a processor unit 40 and a power unit 50 that may be housed between exterior shell 12B and the interior deformable layer(s). In other examples, some or all of these components could be mounted on an exterior of exterior shell 12B and could be protected, if desired, by suitably formed enclosures or the like. In still other examples, some or all of these components could be otherwise connected to frame 12B of helmet 10B. The locations of the components of electronic system 20 (e.g. sensors 30, processor unit 40, and power unit 50) may be different in different examples. In some examples, the grouping of the components of electronic system into the schematic components (e.g. sensors 30, processor unit 40, and power unit 50) is not necessary and the locations of these schematic components may be distributed over a plurality of locations in helmet 10B. For example, some components could be on the right side of helmet 10B and others could be on the left side of helmet 10B to maintain balance of helmet 10B.

Electronic system 20 also comprises a display unit 60. In the illustrated example, display unit 60 is located on an interior of face-protection element 14B, where it may be see by the user when their head is inside helmet 10B, but that allows the user to have a full view out face-aperture 13B. In other examples, display unit 60 may be located in other portions of face-protection element 14B. For example, display unit 60 may extend upward from a top of face-protection element 14B and into face aperture 13B to permit the user to more easily see display unit 60. Face-protection element 14B may be modified to house display unit 60 in a manner that facilitates viewing of display unit 60 by the user when helmet 10B is being worn.

In other examples, display unit 60 may be located in eye-protection element 16B. In such examples, the particular location of display unit 60 in eye-protection element 16B may be selected to allow user to easily see display unit 60 while minimizing the interference of the user's vision through face aperture 13B. In particular, the locations of display unit 60 may be similar to any of the locations described above for display unit 60 within goggles 10. In other examples, helmet 10B may be used in conjunction with goggles, in which case helmet 10B may house some of the components of electronic system 20 (e.g. sensors 30, processor unit 40, and power unit 50) and display unit 60 may be located in the goggles in a manner similar to display unit 60 of goggles 10 described above. In still other examples, helmet 10B may be used in conjunction with goggles and the components of electronic system 20 (e.g. sensors 30, processor unit 40, and power unit 50) and display unit 60 may be distributed over suitable locations in helmet 10B and/or goggles 10.

In the illustrated example, head-mounted information system 10B′ of helmet 10B comprises a plurality of user-interface components 15B (e.g. buttons or other components). A user may interface with head-mounted information system 10B′ using user-interface components 15B in a manner similar to the user interaction with user-interface keys 16 on goggles 10 described herein.

In other respects, helmet 10B may have the features of a traditional helmet (e.g. for a cyclist, skier or motorcyclist).

FIG. 1C shows an underwater mask 10C incorporating a head-mounted information system 10C according to a further example. Mask 10C may have the features of traditional underwater mask for a SCUBA diver or snorkeler, for example. Mask 10C includes processing circuitry configured to implement methods for controlling a virtual keyboard, as discussed below. In the illustrated example, mask 10C comprises a frame 12C that has openings for receiving lens assemblies 11C and 11C. In other examples, mask 10C could comprise a single lens assembly. Lens assemblies 11C and 11C may be coated with an anti-fog sealant. Either of or both the lens assemblies 11C and 11C may be formed to define a recess in order to fit around a display unit 60 (discussed further below). Display unit 60 may be coupled to frame 12C so as to be positioned below a user's right eye when mask 10C is worn, or at any other convenient location, as discussed further below.

Frame 12C and/or lenses 11C and 11C may include a standard ventilation system (not shown) as known in the art. A suitable elastic membrane (e.g., made of rubber or the like) 13C is attached to the inner rim of frame 12C (i.e., the side that faces the user's face). Frame 12C may be held in place by a strap (not shown), that may comprise a standard adjustable elastic head strap that may be worn directly on a user's head (or over a helmet) without sliding down or up.

Frame 12C has enlarged portions referred to herein as “outriggers” 14′ on the left and right sides thereof (individually numbered 14L′ and 14R′, respectively). Outriggers 14′ house portions of an electronic system 20 for a head-mounted information system 10C, as described below with reference to FIG. 2. In the illustrated example, electronic system 20 comprises a sensor unit 30 and a processor unit 40 housed within right outrigger 14R′, and a power unit 50 housed within left outrigger 14L′. Electronic system 20 also comprises a display unit 60 positioned on frame 12C just below the right eye of a user wearing mask 10C for providing information to the user. The locations of the components of electronic system 20 may be different in different examples. Display unit 60 may be positioned to provide for convenient viewing of display unit 60 without overly interfering with the user's sight lines through the remainder of lens assembly 11C. For example, display unit 60 could be positioned below the user's left eye in some examples, or may be positioned above or to the side of either eye. Similarly, sensors unit 30, processor unit 40 and power unit 50 may be positioned at any convenient locations within frame 12C.

One or more user interface keys 16C may be provided on the sides of frame 12C in some examples (two user interface keys 16C are shown on each side of frame 12C in the illustrated example, but a different number of user interface keys could be provided). User interface keys 16C are configured such that they are easily reached by a user and may be tapped or otherwise manipulated while wearing gloves to interact with electronic system 20 of head-mounted information system 10C, as described below. In other examples, other forms of user-interface components could be provided in addition to or in the alternative to user interface keys 16C. Non-limiting examples of such user interface components include: slidable or rotatable user interface components, joystick-type user interface components, optical (e.g. laser or LED-based) user interface components or the like.

In some examples, outriggers 14′ may comprise flat plastic housings 18C embedded within frame 12C on either side of mask 10C that house components of electronic system 20. Housings 18C protect components of electrical system 20 from mechanical stresses. Housings 18C are also water-tight to protect components of electrical system 20 when underwater.

FIG. 1D shows a pair of sunglasses 10D incorporating a head-mounted information system 10D′ according to another example. Sunglasses 10D may have the features of traditional sunglasses useful for driving, sporting activities or leisure, for example. As one skilled in the art will appreciate, head-mounted information system 10D′ could also be incorporated into types of glasses other than sunglasses, such as, for example, prescription glasses, untinted glasses, safety glasses, etc. Sunglasses 10D include processing circuitry configured to methods of controlling a virtual keyboard, as discussed below. Sunglasses 10D comprise a frame 12D that has openings for receiving lens assemblies 11D and 11D′. Lens assemblies 11D and 11D′ may be formed to define a recess in order to fit around a display unit 60 (discussed further below). Display unit 60 may be coupled to frame 12D so as to be positioned below a user's right eye when sunglasses 10D are worn, or at any other convenient location, as discussed further below.

Frame 12D may be held in place by arms 13D and 13D′, and, optionally, a strap or other additional securing means (not shown).

Frame 12D has enlarged portions referred to herein as “outriggers” 14″ on the left and right sides thereof (individually numbered 14L″ and 14R″, respectively). In some examples, outriggers are located on arm 13D and/or arm 13D′. Outriggers 14″ house portions of an electronic system 20 for head-mounted information system 10D′, as described below with reference to FIG. 2. In the illustrated example, electronic system 20 comprises a sensor unit 30 and a processor unit 40 housed within right outrigger 14R″, and a power unit 50 housed within left outrigger 14L″. Electronic system 20 also comprises a display unit 60 positioned on frame 12D just below the right eye of a user wearing sunglasses 10D for providing information to the user. The locations of the components of electronic system 20 may be different in different examples. Display unit 60 may be positioned to provide for convenient viewing of display unit 60 without overly interfering with the user's sight lines through the remainder of lens assembly 11D. For example, display unit 60 could be positioned below the user's left eye in some examples, or may be positioned above or to the side of either eye. Similarly, sensors unit 30, processor unit 40 and power unit 50 may be positioned at any convenient locations within frame 12D and/or arm 13D and/or arm 13D′.

One or more user interface keys 16D may be provided on the sides of frame 12D and/or arm 13D and/or arm 13D′ in some examples (two user interface keys 16D are shown on each side of frame 12D in the illustrated example, but a different number of user interface keys could be provided). User interface keys 16D are configured such that they are easily reached by a user and may be tapped or otherwise manipulated while wearing gloves to interact with electronic system 20 of head-mounted information system 10D′, as described below. In other examples, other forms of user-interface components could be provided in addition to or in the alternative to user interface keys 16D. Non-limiting examples of such user interface components include: slidable or rotatable user interface components, joystick-type user interface components, optical (e.g. laser or LED-based) user interface components or the like.

In some examples, outriggers 14″ may comprise flat plastic housings 18D embedded within frame 12D on either side of sunglasses 10D that house components of electronic system 20.

Housings 18D protect components of electrical system 20 from mechanical stresses. Housings 18D may also be water-tight in some examples to protect components of electrical system 20 from moisture.

In other respects, sunglasses 10D may have the features of traditional sunglasses useful for driving, sporting activities or leisure, for example.

FIG. 2 is a block diagram of an example electronic system 20 suitable for use with head-mounted information system 10′ of goggles 10, head-mounted information system 10B′ of helmet 10B, head-mounted information system 10C′ of mask 10C and/or head-mounted information system 10D′ of sunglasses 10D according to one example. As discussed above, electronic system 20 comprises sensor unit 30, processor unit 40, power unit 50 and display unit 60. It will be appreciated that goggles 10, helmet 10B and mask 10C represent non-limiting examples of devices that may incorporate head-mounted display systems incorporating electronic system 20. In other examples, head-mounted information systems may be provided in a variety of head-mounted devices, such as, by way of non-limiting example: other types of eyewear or eye protection devices (e.g. sunglasses, protective glasses or the like), other types of helmets (e.g. ski helmets, snowmobiling helmets or the like), other types of masks and/or hands-free mobile communication devices (e.g. hands free devices for mobile phones, PDAs, tablet computers, portable music players or the like).

Wiring connecting units 30, 40, 50 and 60 may be enclosed within channels formed in frame 12, 12C or 12D (in the case of goggles 10, mask 10C or sunglasses 10D) or between exterior shell 12B and the deformable interior layer (in the case of helmet 10B), or may be enclosed within a separate casing (not shown). In some examples of goggle 10, mask 10C or sunglasses 10D where sensor unit 30 and processor unit 40 are located in right outrigger 14R/14R′/14R″, power unit 50 is located in left outrigger 14L/14L′/14L″, and display unit is located below the user's right eye, power wiring connecting sensor, processor and display units 30, 40 and 60 to power unit 50 may be routed across the upper portion or “bridge” of frame 12/12C/12D, with the power wiring for display unit 60 continuing on around the lower right rim of frame 12/12C/12D. Similarly wiring connecting processor unit 40 to display unit 60 for providing image signals to display unit 60 may be routed around the lower right rim of frame 12/12C/12D. In some examples of helmet 10B where face-protection element 14B is detachable, the wiring to display unit 60 may comprise detachable wiring connections (e.g. plugs). In some examples of helmet 10B where display unit 60 is located in eye-protection element 16B, the wiring to display unit 60 may be routed through one or both pivot joints 18B.

In the illustrated example, sensor unit 30 comprises a three-axis accelerometer 32, a three-axis gyroscope 34, a GPS receiver 36, and a thermometer 38. Accelerometer 32 and gyroscope 34 are collectively referred to herein as “IMU” (inertial monitoring unit) sensors. The IMU sensors 32, 34 and GPS receiver 36 have complementary strengths and weaknesses such that their combined use provides for improved reliability and accuracy of measurement of position and altitude as compared to each sensor on its own. Examples of such complementary strengths and weaknesses are described, for example, in “Experimental system for validating GPS/INS integration algorithms”, Niklas Hjortsmarker, ISSN 1402-1617, and “Global Positioning Systems Inertial Navigation And Integration”, 2nd edition, Mohinder S. Grewal et all, ISBN-13 978-0-470-04190-1, that are hereby incorporated by reference herein.

Accelerometer 32 may comprise, for example, a micro-electro-mechanical system (MEMS) device that produces digital output signals representative of linear accelerations along three perpendicular axes. In some examples, accelerometer 32 may comprise a LIS331DL motion sensor manufactured by STMicroelectonics.

Gyroscope 34 may comprise, for example, two MEMS devices, one of which produces analog output signals representative of angular velocities about two perpendicular axes, and one of which produces an analog output signal about a third axis perpendicular to the other two axes. In some examples, gyroscope 34 may comprise an IDG-500 for measuring angular velocities about an X-axis and a Y-axis, and an ISZ-500 for measuring angular velocity about a Z-axis, both of which are manufactured by InvenSense, Inc.

GPS receiver 36 may comprise, for example a Wide Area Augmentation System (WAAS) enabled GPS receiver with a built-in system clock. GPS receiver 36 may, for example, output digital signals using a protocol such as NMEA 0183 or NMEA 2000. Thermometer 38 may comprise, for example, a digital thermometer.

In other embodiments, sensor unit 30 may comprise one sensor, some combination of sensors described above or other sensors such as 3G signal receivers, wireless internet receivers, audio radio receivers, television or video receivers or the like.

Processor unit 40 comprises a processor 42 that is connected to receive signals from accelerometer 32, gyroscope 34, GPS receiver 36 and thermometer 38 of sensor unit 30. Processor unit 40 may comprise an analog-to-digital converter (ADC) 44 connected between processor 42 and any of the sensors of sensor unit 30 that produce analog signals. In the illustrated example, all sensors of sensor unit 30 except gyroscope 34 have digital outputs, so ADC 44 is connected only between gyroscope 34 and processor 42.

In the illustrated example, processor unit 40 also comprises a memory 46. Memory 46 may comprise volatile and/or non volatile memory such as RAM, ROM, or other types of memory. Memory 46 may also comprise a removable media such as a USB drive, SD or miniSD card, etc. Memory 46 has stored therein various computer readable instructions for use by processor 42. In other examples, memory 46 may be integrated into processor 42.

Processor 42 may also be coupled to communications port 47 and power button 48. Communications port 47 may be accessible to a user and comprise one or more interfaces for wired or wireless communication with external devices. Communications port 47 may, for example, comprise one or more USB, Firewire, or other interfaces. Power button 48 may also be accessible to the user and operable to turn electronic system 50 on and off.

Processor unit 40 may also send and receive information from other devices such as mobile phones, personal computers, other modular HUD systems, etc. For example, processor 42 may receive images or video from a video camera 78 (which may either be a camera coupled to the head mounted information system, or a separate camera) and send the same via an appropriate communications method. For example, in some embodiments processor 42 may control display 64 to act as a viewfinder for video camera 78 by displaying live images from video camera 78. Display of live images from camera 78 on display 64 may facilitate users capturing of intended scenes by providing feedback to users as to where camera 78 is pointing. Processor 42 may also cause display 64 to display stored images captured with video camera 78. Video camera 78 may be configured to capture both still and moving images in some embodiments. Video camera 78 may be physically connected to electronic system 20 or may be wirelessly connected through a Bluetooth communication protocol or other suitable communications methods. Processor 42 may also receive input commands from a remote control 79. Remote control 79 may be wirelessly connected to processor unit 40 and may comprise a wireless watch-type remote or be integrated into a user's gloves or mitts for example. Remote control 79 may also be integrated into video camera 78.

In some embodiments, remote control 79 may include a thermometer 79′, and remote control 79 may be configured to transmit temperature readings taken by thermometer 79′ to processor unit 40. Providing temperature readings taken by thermometer 79′ in remote control 79 may provide for simplified temperature calibration in some embodiments, since remote control 79 may not be susceptible to as many thermal disturbances as thermometer 38 of sensor unit 30, which is typically located close to the user's head and may be covered by a hat or other articles. Providing thermometer 79′ in remote control 79 may thus improve the accuracy of temperature readings in some embodiments. In some embodiments, thermometer 79′ may be used in conjunction with thermometer 38 of sensor unit 30. In some embodiments, thermometer 38 of sensor unit 30 may be omitted, and thermometer 79′ may provide the only temperature readings to processor unit 40.

Processor 42 is configured to transform signals received from sensor unit 30 to produce outputs representing various parameters relating to user performance, and other outputs. For example, processor 42 may produce outputs relating to one or more of position, orientation, time, speed, direction of travel, altitude, vertical drop, jump airtime, jump distance, spins, etc. Processor 42 may store the outputs and/or any other data in memory 46, or transfer them to another device through communications port 47.

Processor 42 also produces a video signal 61 to be displayed by display unit 60. The content of video signal 61 may be controlled, as least in part, by user gestures as described below, and may also be controlled by the user interfacing with user interface keys 16, or by another electronic device interacting with processor 42 through communications port 47. In some embodiments, the video signal 61 produced by processor 42 for displaying on display 64 comprises one or more of:
an instantaneous speed indication;
an average speed indication;
a position indication;
an orientation indication;
a direction of travel indication;
an altitude indication;
a vertical drop indication;
a jump airtime indication;
a jump distance indication;
a jump rotation indication;
other motion indications;
live or stored images from a camera (such as camera 94 or another camera);
communication indications (e.g., text messages, emails, call indications, voicemail indications, etc.); and
other visual indications.

Power unit 50 comprises a battery 52 and a power conditioning circuit 54. Power conditioning circuit 54 receives electrical power from battery 52 and outputs electrical power at voltages and/or currents suitable for the various components of sensor unit 30, processor unit 40, and display unit 60. In some embodiments, power conditioning circuit 54 may comprise temperature control elements and short circuit protection elements contained in power unit 50. In some embodiments, power conditioning circuit 54 may comprise power management elements contained in power unit 50.

Display unit 60 comprises a display driver 62 connected to receive video signal 61 from processor 42. Display driver 62 is configured to generate driving signals based on video signal 61, and to provide the driving signals to a display 64. In some embodiments, display driver 62 may be directly connected or connectable to receive video signals from camera 78. Display 64 may comprise, for example, a QVGA having a 320×240 resolution and 16 bit colors. In some examples, display 64 may comprise a micro LCD illuminated by a suitable backlight. In other examples, other types of displays may be used, such as, for example, LED or OLED displays, electroluminescent (EL) displays, or the like. Display 64 is configured to project the image defined by video signal 61 from processor 42. Display unit 60 may also comprise a display lens assembly 66 positioned to receive the image projected by display 64. Display lens assembly 66 may be configured to enlarge the projected image and/or to focus the projected image for convenient viewing by a user.

Display unit 60 may also comprise a glance detection unit 93 in some embodiments. Glance detection unit 93 is configured to detect when a user looks at display 64. Glance detection unit 93 may be operatively coupled to display driver 62 and configured to provide a signal to display driver 62 indicative of whether or not the user is looking at display 64, and display driver 62 may be configured to maintain display 64 in an off state or a power saving state unless the user is looking at display 64. In some embodiments, glance detection unit 93 may comprise an infrared transmitter and an infrared receiver operatively coupled to processing elements. The infrared transmitter emits infrared light which reflects off of a user's eye and is received by the infrared receiver. Through appropriate calibration, the processing elements of glance detection unit 93 may determine from the reflected infrared light received at the infrared receiver whether or not the user is looking at display 64. In other embodiments, of glance detection unit 93 may comprise one or more brightness sensors configured to capture ambient light reflecting off of a user's eye to determine whether or not the user is looking at display 64. Further details of example methods, apparatus and systems for controlling display 64 based on where the user is looking are described in U.S. provisional patent application No. 61/682,675, which is hereby incorporated by reference herein.

A microphone 96 for receiving voice commands and other sound inputs, and a speaker 98 for outputting sound may also optionally be operably coupled to processor unit 40 in some embodiments. The microphone 96 and speaker 98 may be located at any convenient location.

Display unit 60 may be housed within a removable casing (not shown). Such a removable casing may be detachably received within a complementary-shaped recess in frame 12, 12C or 12D (in the case of goggles 10, mask 10C or sunglasses 10D), or between exterior shell 12B and the interior deformable layer (in the case of helmet 10B). The casing for display unit 60 may comprise a box-type or “clam shell”-type construction having a lower half and an upper half that may be opened (e.g. for access) or closed (e.g. to form a watertight enclosure). A separate moisture sealing gasket may mounted between the two halves before they are closed (e.g. snapped and/or screwed together) to form a moisture tight enclosure. The casing may define a series of compartments each designed to individually secure a display module, display back light, display lens and electrical connections. The casing may be held in place within a complementary recess by the walls of the recess itself, along with hooks and/or snaps or the like that may be molded into, or otherwise provided, on mating surfaces of the casing and/or the recess. The casing may additionally be held in place by screws coupleable to the exterior casing walls.

As one skilled in the art will appreciate based on the foregoing description, head-mounted information systems according to certain examples of the invention may be provided in a variety of different head-mounted devices (e.g. eyewear, helmets, masks, mobile communication devices and the like), or may be provided in a modular display system configured to be coupled to goggles, helmets, glasses or the like, as described for example in U.S. provisional patent application Nos. 61/502,568, 61/563,480 or 61/658,731, or International patent application No. PCT/CA2012/050121, all of which are hereby incorporated by reference herein. In the following description, examples of head-mounted information systems are described in the context of head-mounted display system 10′ of goggles 10 shown in the illustrated example of FIG. 1 without loss of generality. It will be understood that the description provided herein is applicable in a similar manner (with suitable modification) to the control of head-mounted information systems provided in helmets (e.g. helmet 10B), masks (e.g., mask 10C), glasses (e.g., sunglasses 10D) or in other head-mounted devices.

In some examples, electronic system 20 of head-mounted information system 10′ of goggles 10 may be turned on and off using a user-interface key on the frame of the goggles or by tapping one of the outriggers of the frame. Once the electronic system is powered on, the default view appears in the display showing information relating to the user's activity. The user may switch between views by pressing or otherwise interacting with user interface keys on the frame or by tapping one of the outriggers of the frame. The user may customize his or her own view(s) by connecting the head-mounted information system to a personal computer or other external device. Each view may be tailored to a particular activity to provide suitable information with a minimum requirement for user interaction during the activity. For example, during jumps in a fun-park, the user may select a jump view to display information such as jump airtime and distance. Similarly, if the activity is downhill skiing then a downhill view may be selected to show speed, distance, and optionally altitude. Information that is independent of the activity such as temperature, time, and text/call info may always be shown, but the display of such additional information is up to the user to decide and configure. Furthermore, the electronic system of the head-mounted information system may be configured to accept Bluetooth and other communication protocols that allow for mobile text messages and call info to be received and displayed to the user at any time, depending on user preference. Staying connected while performing activities has many benefits. By way of non-limiting example, staying connected may be desirable on the ski mountain, where coordination of activities such as lift access, refreshments, and meeting places is part of the daily rhythm.

Another benefit provided by some examples is safety—with the push of a user interface key, GPS coordinates may be sent to ski patrol or other emergency responders for fast rescue in an emergency. Also, the USB integration enables users to upload data from their head-mounted information system to a personal computer or other external device to track performance and to compare results with others (e.g. other riders and skiers within an online community). By way of example only, the online community could feature way-point download for those desired off-path sights as well as air-time (jumps) rankings and prizes.

A virtual keyboard may be displayed on a display of an electronic device, such as a head-mounted device or another type of electronic device. The virtual keyboard may be any suitable keyboard such as a QWERTY keyboard, an ABC keyboard, and the like. The virtual keyboard includes a number of virtual keys, with each key associated with a character, number, symbol or other input that may be entered using the virtual keyboard. The keyboard may be displayed in any application or activity such as an email, text messaging or chat application, a calendar or contacts application, or any other application where text input is made.

Improved methods and systems for inputting text into electronic devices are desirable. Certain methods and systems described herein may be particularly suited for head mounted devices, but it is to be understood that methods and systems according to the present disclosure may be implemented in any type of electronic device including a display, a user interface for receiving inputs, and suitable processing capabilities. Examples of suitable electronic devices include head mounted devices as described above, desktop computers, laptop computers, tablet computers, handheld electronic devices, gaming consoles, set top boxes, and the like.

Advantageously, a virtual key layout together with an indication of an active position as described below may be displayed on a display of an electronic device, such as a head-mounted device. The virtual key layout may be displayed in any context where test input is desired. For example, in some embodiments a virtual key layout is automatically displayed whenever a text entry field is selected. The virtual key layout may be configured to include multiple columns of keys and multiple rows of keys and may be controlled, or navigated, using directional inputs while maintaining the active position at a first, fixed location of the key layout. Entry of text using a virtual key layout that is controllable by use of directional inputs facilitates one-handed or no-handed operation of the electronic device and provides a convenient mechanism to locate and select individual keys of a virtual key layout. In some embodiments for use with head mounted electronic devices, directional and other inputs may be provided to the electronic device using gestures, as described for example in International Publication No. WO/2011/044680, which is hereby incorporated by reference herein.

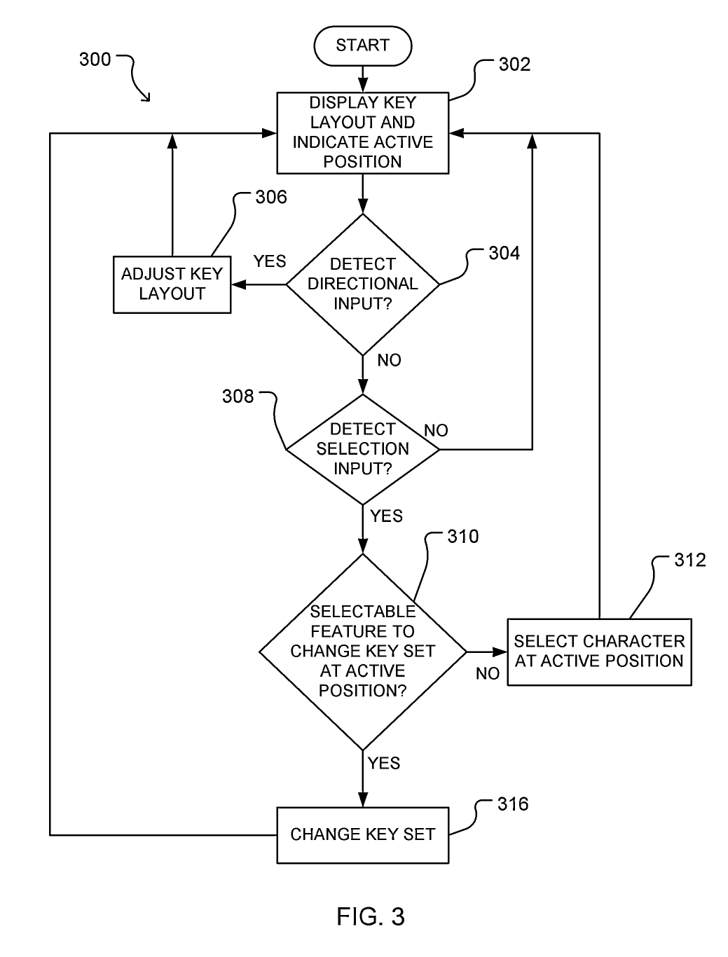

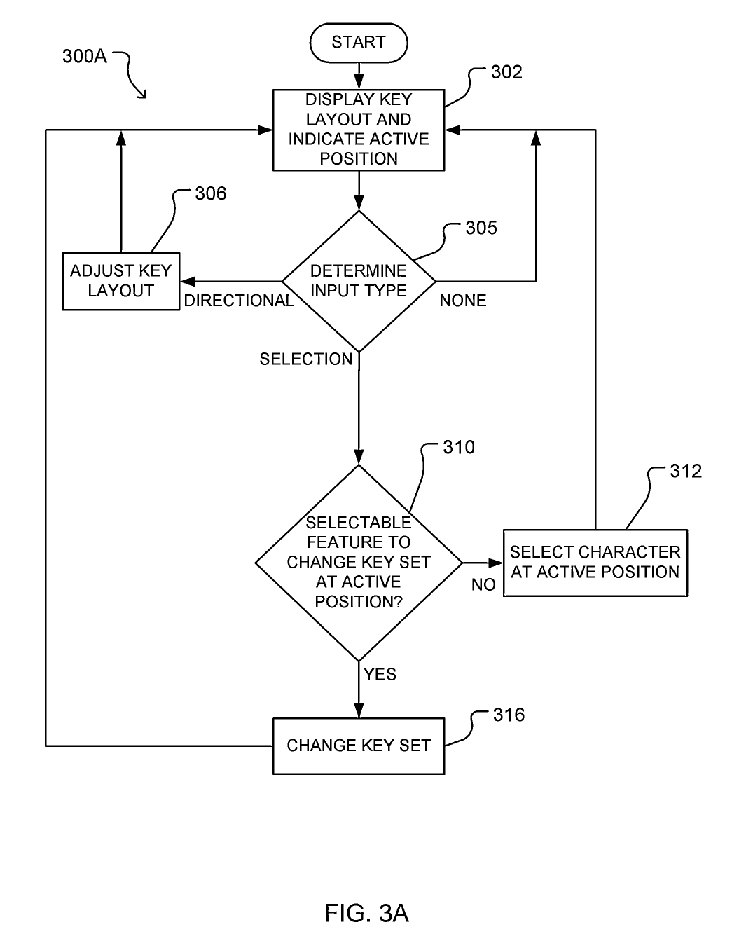

A flowchart illustrating an example of a method 300 for controlling a virtual key layout on a display of an electronic device, such as a head-mounted device 10, is shown in FIG. 3. The method 300 may, for example, be carried out by the processor 42 of device 10, or by any suitably configured processor or combination of processing elements of other electronic devices (referred to below as “the processor” for simplicity's sake). Computer-readable code containing instructions to perform the method 300 may be stored in a computer-readable storage medium accessible by the processor. Additional or fewer steps may be performed beyond that shown or described, and the steps may be performed in a different order.

A virtual key layout including an indication of an active position is displayed (e.g. on the display unit 60) at 302. The virtual key layout includes a plurality of rows of virtual keys and a plurality of columns of virtual keys. The active position is located at a first, fixed location for selecting one of the keys. Indicating the active position may include displaying a cursor at the active position, highlighting the key at the active position, highlighting the column of keys and/or the row of keys containing the first, fixed location, or any combination thereof. The highlighting may include increasing a font size of the keys in the column and row containing the first, fixed location, and/or may include fading, blurring, and/or dimming the other columns and rows of the keyboard.

At 304 the processor monitors user inputs to detect a directional input. A directional input is any input that provides an indication of a direction for adjusting the key layout, such as one of “up”, “down”, “left”, and “right” inputs. Some embodiments may also be configured to accept diagonal directional inputs such as one of “up-right”, “up-left”, “down-right” and “down-left.” A directional input may be provided by a joystick, directional pad, or any other user interface method such as a swipe gesture on a touch-sensitive pad, recognition of a head movement, an eye movement, a movement of the electronic device or a verbal command, and the like. In embodiments for use with head mounted displays, a directional input may, for example, comprise a head motion (e.g., twisting or tilting) in the desired direction.

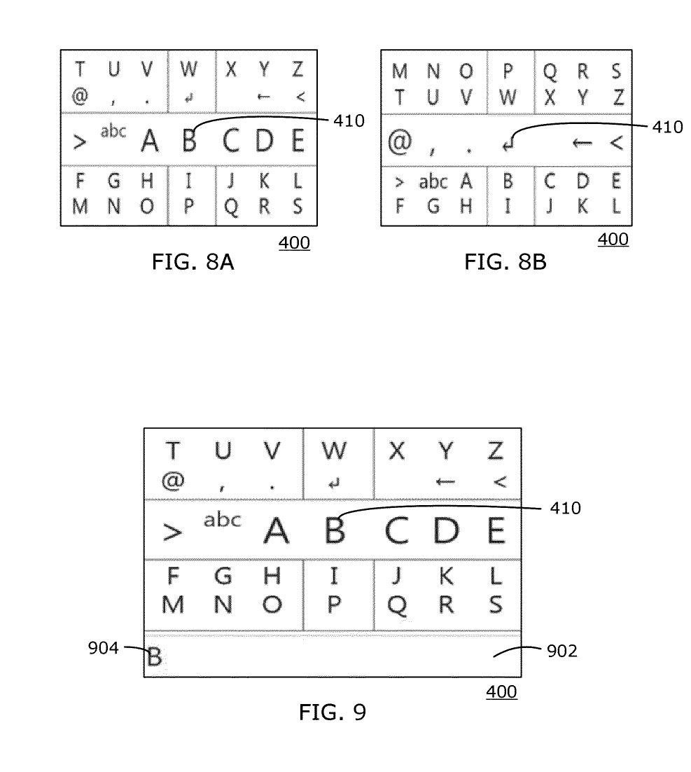

Upon detection of a directional input, the method 300 proceeds to 306 where the processor performs a function associated with the directional input. The function may be a key layout adjusting function. A key layout adjusting function is a function to adjust (e.g. shift) the locations of keys in the layout based on the directional input while maintaining the active position at a first, fixed location, such as a central location. Adjusting of the key layout may be graphically animated to facilitate identification of the new locations of the keys of the virtual key layout. After adjusting the key layout at 306, the method 300 returns to 302 where the adjusted key layout is displayed with a new key indicated as the active key. Examples of adjustments to the key layout are described below with reference to FIG. 7A, FIG. 7B, FIG. 8A and FIG. 8B.

When no directional input is detected at 304, the method 300 proceeds to 308 where the processor monitors user inputs to detect a selection input. A selection input is any input for selecting an indicated character or executing an indicated function. A selection input may be provided by a joystick, or any other user interface method such as a touch or hold gesture on a touch-sensitive pad, recognition of a head movement, an eye movement, a movement of the electronic device or a verbal command, and the like. In some embodiments, a directional pad may be provided for entering directional inputs, and a central portion of the directional pad may be operable (e.g., by pressing or “clicking” the central portion) for entering a selection input. In embodiments for use with head mounted displays, a selection input may comprise, for example, any suitable change in acceleration, repeated motion or change in axes of motion. For example, in some embodiments a selection input could be effected by one or more taps (e.g., a single or double tap on the frame or other portion of a head mounted device), or a double head nod. In some embodiments, only left and right directional inputs may be accepted, in which case a single head nod may be used to affect a selection input. Alternatively, an acceleration threshold could be used to distinguish a head nod used as a selection input from a directional input (e.g., forward head tilting with an angular acceleration of at least a threshold value may be interpreted as a selection input, while forward head tilting with an angular acceleration below the threshold value may be interpreted as a down input).

When no selection input is detected at 308, the method 300 returns to 302 and the processor continues to monitor user inputs until a directional input is detected at 304 or a selection input is detected at 308. In some embodiments a timeout may occur if no inputs are received for a predetermined timeout period, at which point the processor may turn off or dim the display in order to save power, enter into a power saving mode where certain processor functions are, and/or exit a text entry mode. As one skilled in the art will appreciate, the order of the steps performed by the processor at 304 and 308 may be reversed, or the steps may be performed in parallel. For example, FIG. 3A shows another example method 300A where the processor determines an input type at 305. If a directional input is detected the method 300A proceeds to 306 where the processor performs a function associated with the directional input as described above. If a selection input is detected the method 300A proceeds to 310 where the processor determines if a selectable feature to change the key set is in the active position as described below. If no input, or no recognizable or valid input, is detected the method 300A returns to 302 and the processor continues to monitor user inputs. The method 300A of FIG. 3A is otherwise the same as the method 300 of FIG. 3.

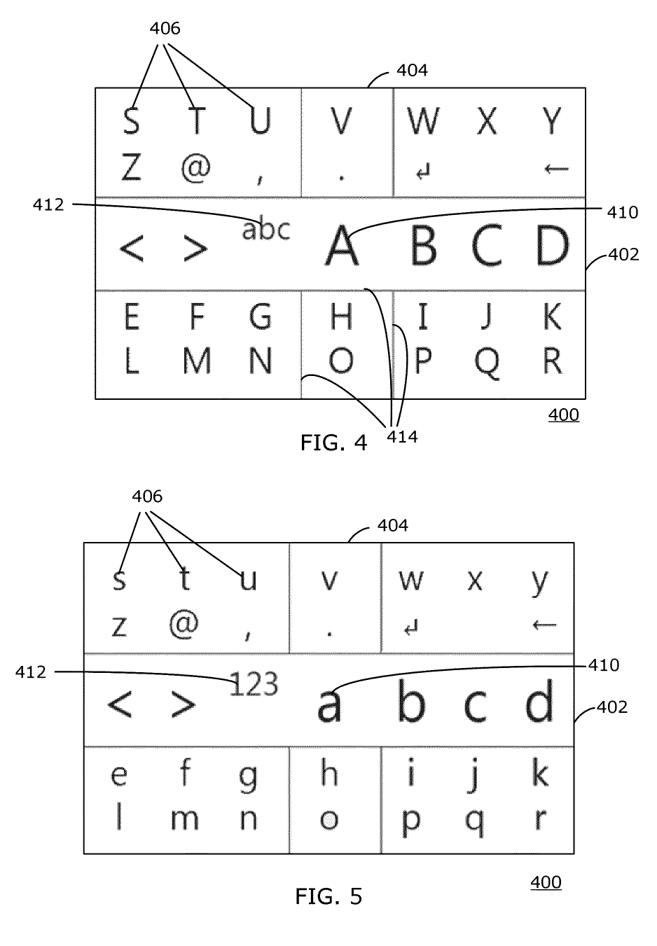

When a selection input is detected (at 308 in FIG. 3 or 305 in FIG. 3A), the method 300/300A proceeds to 310 where the processor determines the type of key at the active position in order to determine a function associated with the selection input. If the key at the active position is a character, the method 300/300A proceeds to 312 where the processor selects the character for text entry (e.g., into a currently selected text entry field). For example, if the active position is associated with the “A” key, as shown in FIG. 4, then a selection input may enter the associated character “A” to an active text entry field, or the like. The entered text may be displayed in the text entry field at a location that is indicated by a text cursor, such as a steady or flashing caret or vertical bar. After selecting the character for text entry at 312, the method 300/300A returns to 302 and the processor continues to monitor user inputs.

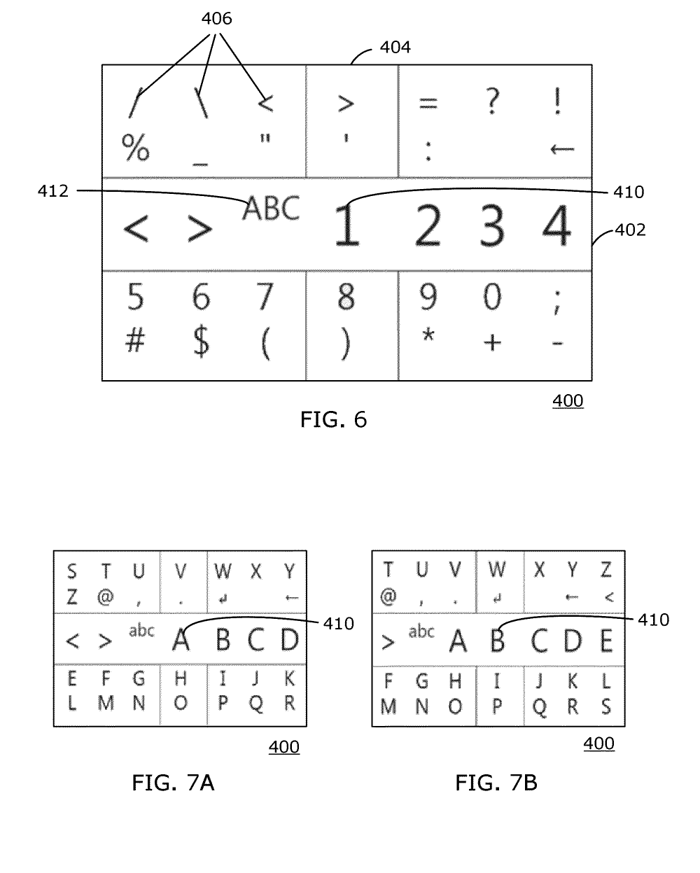

Upon the selection input being detected at 310, if the key at the active position is a selectable feature to change the key set then the function associated with the selection input may be a function to change the keys of the virtual key layout from a first key set to a second key set (shown at 316 of FIG. 3 and FIG. 3A). Alternative key sets may contain keys associated with character sets of upper case letters, lower case letters, numbers, punctuation, letters used in other languages, emoticons, and the like. For example, the selectable feature may be a number key (which may be labeled “123”) and selecting the number changes the keys of the key layout to a set of keys that includes keys associated with a character set of numbers and punctuation symbols, as described further below with reference to FIG. 4, FIG. 5 and FIG. 6. After changing the key set at 316, the method 300/300A returns to 302 and the processor displays the key layout with the new key set and continues to monitor user inputs.

Examples of controlling a virtual key layout displayed on a display unit 60 are illustrated in FIG. 4 through FIG. 11 and described with continued reference to FIG. 3 and FIG. 3A. In the front view of FIG. 4, a key layout 400 is displayed on the display unit at 302. The key layout 400 includes a plurality of keys 406 that are organized in a grid of columns and rows such as, for example, five rows and seven columns containing thirty-five keys 406. The keys 406 occupy the positions, row-wise and column-wise, of the key layout 400. It will be appreciated that alternative key layouts may be used that are only partially organized in a grid, or that are organized in a grid that is not uniformly spaced.

In this example, the key layout 400 is made up of an odd number of columns of keys and rows of keys. An active position 410 including a central or middle row outline 402 and a central or middle column outline 404 facilitates the highlighting of a key at a first, fixed or, in the illustrated example, a central location, which is occupied by the “A” key. The highlighting may further or alternatively include increasing or decreasing the font size, colour, shading, and the like, of keys. The highlighting may include blurring or dimming the columns and rows that are not the central column and central row. In this example, the keys contained in the central row 402, that is, the “<”, “>”, “abc”, “A”, “B”, “C”, and “D” keys are displayed in a font size that is larger than the font size of the rest of the keys of the key layout 400. As well, lines 414 provide an outline for the central column 404 and the central row 402. The key layout 400 may include a layout of keys from the character set for upper case letters (shown in FIG. 4). Alternatively, the key layout 400 may include a layout of keys from the character set for lower case letters (shown in FIG. 5), or for numbers and punctuation symbols (shown in FIG. 6). The key layout 400 may contain keys that include upper and lower case letters, and a selection of symbols and numbers.

The keys of the key layout 400 may also include symbols associated with functions such as a backspace, move text active position left, move text active position right, enter, space, and a selectable feature 412 to change the key set of the key layout 400 (discussed in more detail below).

In the example of FIG. 4, the key layout 400 includes a key set of twenty-six upper-case letters, eight commonly used punctuation or other symbols (“@”, “,”, “.”, “<”, “>”, enter, space, backspace) and a selectable feature 412 (associated with the key labeled “abc”) to change the key set, as discussed in more detail below. It will be appreciated that the key layout 400 may include a greater or lesser number of keys and/or selectable features and further, the rows and columns making up the key layout 400 need not be uniform as each row or column could contain a greater or lesser number of keys and/or selectable features than adjacent or other rows or columns, respectively.

In the example of FIG. 7A and FIG. 7B, a directional input is detected at 304/305. The directional input is a right input (in a horizontal direction). In response to the directional input, a key layout adjusting function is performed to adjust the key layout while maintaining display of the indication of the active position 410 at a first, fixed location of the key layout. The result of the key layout adjusting function is shown in FIG. 7B. In this example, the active position 410 is maintained and the virtual key layout is adjusted, or shifted, such that the location of each key of the virtual key layout is moved by one position in a direction (in this case, left) opposite the directional input (in this case, right). The key layout is adjusted at 306 and the location of the active position 410 is maintained with the active position being associated with the “B” key in FIG. 7B (changed from the “A” key in FIG. 7A). It is observed that the location of the “B” key has shifted by one position to the left and is now in the active position 410. Keys located in the leftmost column of the virtual key layout 400 are re-located one row position higher to occupy the key locations “vacated” at the opposite, rightmost column of the virtual key layout 400. For example, the “L” key is moved from a left location (in FIG. 7A) to a right location that is one row position higher (in FIG. 7B). The key located at the top, left location of the virtual key layout 400 (the “S” key in FIG. 7A) is re-located to the bottom, right location of the virtual key layout 400 (the “S” key in FIG. 7B). In this manner, a user may perform directional inputs to the right and thereby navigate or browse through the keys by use of the directional inputs. Detection of a left direction input shifts the virtual key layout in the opposite direction. It will be appreciated that any one of the keys of the virtual key layout 400 may be “shifted” to be in the active position 410, through repeated left or right directional inputs, to facilitate location and selection of a desired key.

In the further example of FIG. 8A and FIG. 8B, a directional input is detected at 304/305. The directional input is an up input (a vertical direction). In response to the directional input, a key layout adjusting function is performed to shift the key layout while maintaining display of the active position 410 at a first, fixed location of the key layout. The result of the key layout adjusting function is shown in FIG. 8B. In this example, the active position 410 is maintained by shifting the virtual key layout such that the location of each key of the virtual key layout is shifted by one position in a direction (in this case, down) opposite the directional input (in this case, an up input). The key layout is controlled at 306 and the active position 410 is maintained with the active position 410 being associated with the “enter” key in FIG. 8B (changed from the “B” key in FIG. 8A). It is observed that the location of the “enter” key has shifted by one position down and is now in the active position 410. Keys located at the bottommost row of the virtual key layout 400 are re-located to occupy the key locations vacated at the opposite, topmost row of the virtual key layout 400. For example, the location of the bottom row of keys, including the “M” key, is moved from a bottom location (in FIG. 8A) to a top location (in FIG. 8B) of the virtual key layout 400. Detection of a down input shifts the virtual key layout in the opposite direction. In this manner, a user may be able to more quickly navigate or browse the key layout to move a desired key to the active position 410 as compared to only using left and right directional inputs. Diagonal inputs (e.g., an up-right input, an up-left input, a down-right input or a down-left input), when detected, may cause a respective horizontal and vertical shift of the virtual key layout. For example, an up-right input may cause a downward shift then a leftward shift of the virtual key layout, or a leftward shift then a downward shift of the virtual key layout, or substantially simultaneous downward and leftward shifts of the virtual key layout.

In each of the examples of FIG. 7A, FIG. 7B, FIG. 8A, and FIG. 8B, detection of a selection input (at 308/305) will select (at 312) the key associated with the active position 410, that is, “A”, “B”, “B”, and “enter”, respectively. For example, as shown in FIG. 9, selection of the “B” key results in the selecting a character input, for example the “B” character, associated with the key at the active position. The selected character 904 may be displayed in a text entry field 902.

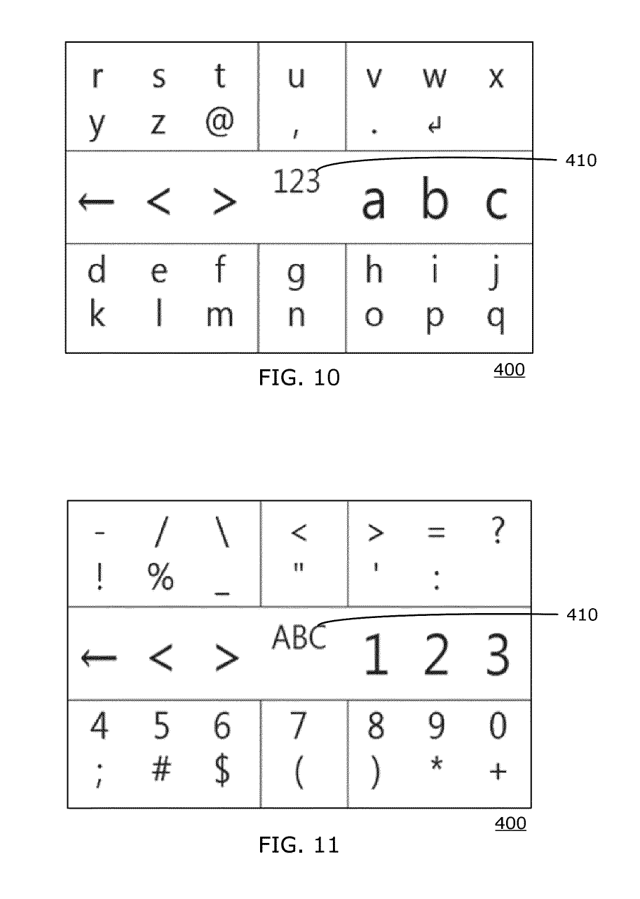

With reference to FIG. 10, the key set changing function is a function to change the key set by from a first key set to a second key set. The key set is changed at 316. The changed key set is illustrated at FIG. 11. For example, upon selection of the key associated with a selectable feature, as for example, the key associated with the selectable feature 412 (labeled “123” shown in the field of the active position 410 of FIG. 10), a key set changing function is performed to change the key set to an alternative key set for a character set of numbers and punctuation symbols, as shown in FIG. 11. The key set change function may also change the label for the key associated with the selectable feature. For example the label may change from “123” to “ABC” or from “ABC” to “abc” to indicate any of the multiple key sets available. Also, in some embodiments, more than one selectable feature key may be displayed in a key layout.

By way of non-limiting example, the devices and methods disclosed herein may be used in sporting activities, such as snowboarding, skiing, snowmobiling, cycling (including motorcycling, moto-cross and mountain biking), kite surfing, sky diving, cross country running, SCUBA diving, snorkeling, and the like. Such sporting activities may be enhanced by head-mounted information systems according to examples. Suitable sporting activities may include any activities in which participants typically use goggles, helmets, masks, sunglasses or other head-mounted devices during the activities, but other examples can be used in other activities (i.e. activities wherein participants do not typically used head-mounted devices). In other examples, head-mounted information systems similar to those described herein can be used in military, police, or rescue settings. Certain examples provide lightweight affordable solutions that are non-obtrusive for front and peripheral vision enabling features such as navigation, buddy tracking, silent communication direct to eye, emergency GPS coordinate dispatch to HQ, and various performance measurements using built-in sensors and/or wireless connectivity to external devices and services. In yet another example, traditional endurance sports such as triathlon, running, speed skating, cycling, and rowing may also benefit from devices. These endurance sports would benefit from easily accessible performance read-outs during the activity. Other activities may be enhanced. In one example, head-mounted information systems may record a wearer's activities and upload this to online software applications that may share with a community. For example, head-mounted information systems may record a user's moves on the mountain and facilitate uploading of three-dimensional approximations of such moves to an online community. Head-mounted information systems may also be capable of downloading information (e.g. a professional snowboarder's moves). Such downloaded information may be used to practice while receiving instructions direct to eye during the activity. The systems may be used for instructional purposes, where physical activity is involved making normal paper or pocket based aids inconvenient.

In some examples, the processor 42 may be configured to convert certain head movements, or combinations of head movements to specific inputs, to allow for “shortcut” movements for executing certain inputs. For example, the processor 42 may be configured to convert a double head tilt to one side into a “select” input during menu navigation, or a “fast forward” input during a video playback in some examples. As another example, a circular motion with the head might be converted to another particular input. Such shortcut movements for executing specific inputs may be preprogrammed (e.g., as movement profiles) into the instructions running on the processor, and may be user-configurable or calibratable in some examples.

Certain implementations comprise computer processors that execute software instructions that cause the processors to perform a method as disclosed herein. For example, one or more processors in a head-mounted display apparatus may implement the method of FIG. 3 or FIG. 3A by executing software instructions in a program memory accessible to the processors. The invention may also be provided in the form of a program product. The program product may comprise any medium which carries a set of computer-readable instructions which, when executed by a data processor, cause the data processor to execute a method of the invention. Program products according to the invention may be in any of a wide variety of forms. The program product may comprise, for example, physical media such as magnetic data storage media including floppy diskettes, hard disk drives, optical data storage media including CD ROMs, DVDs, electronic data storage media including ROMs, flash RAM, or the like. The computer-readable instructions on the program product may optionally be compressed or encrypted.

Where a component (e.g. a software module, processor, assembly, device, circuit, etc.) is referred to above, unless otherwise indicated, reference to that component (including a reference to a “means”) should be interpreted as including equivalents of that component and any component which performs the function of the described component (i.e., that is functionally equivalent), including components which are not structurally equivalent to the disclosed structure which performs the function in the illustrated example.

As one skilled in the art will appreciate, the examples discussed above are for illustrative purposes only, and methods as disclosed herein may be implemented in any suitable device having appropriately configured processing hardware. Such processing hardware may include one or more conventional processors, programmable logic devices, such as programmable array logic (“PALs”) and programmable logic arrays (“PLAs”), digital signal processors (“DSPs”), field programmable gate arrays (“FPGAs”), application specific integrated circuits (“ASICs”), large scale integrated circuits (“LSIs”), very large scale integrated circuits (“VLSIs”) or the like.

A method includes, on a display of an electronic device, displaying a key layout, the key layout comprising a plurality of rows of keys and a plurality of columns of keys, displaying a active position at a first, fixed location for selecting one of the keys, detecting user navigation comprising a directional input, and in response to the directional input, controlling the key layout while maintaining display of the active position at the first location.

An electronic device includes a frame configured to be mounted on a head of a user, a display unit coupled to the frame, the display unit comprising a display for producing an image, a sensor unit coupled to the frame, the sensor unit comprising one or more motion sensors, and at least one processor coupled to the display unit and the sensor unit and configured to, display a key layout, the key layout comprising a plurality of rows of keys and a plurality of columns of keys, display a active position at a first location for selecting one of the keys, detect user navigation comprising a directional input, and in response to the directional input, control the key layout while maintaining display of the active position at the first location.

The method may further include detecting user selection of one of the keys, and in response to the selection input, selecting a character input associated with the key at the first location. One of the keys may include a selectable feature to change the key set, and the method may include, in response to the selection input, when the key comprising the selectable feature is at the active position, changing the key set from a first key set to a second key set.

The first and second key sets may include keys associated with character sets selected from one of: upper case letters, lower case letters, numbers, languages, and emoticons.

The directional input may include one of: an up input, a down input, a left input, a right input, an up-right input, an up-left input, a down-right input and a down-left input. The directional input may include a first direction, and controlling the keyboard may include shifting the keys of the key layout in a direction opposite the first direction. The locations of the keys may be moved by at least one position in a direction opposite the first direction.

The shifting may include moving the location of keys at a first horizontal end of the key layout opposite the first direction to a second horizontal end of the key layout opposite the first horizontal end when the first direction is a horizontal direction. When the first direction is a vertical direction, shifting may include moving the location of a row of keys at a first vertical end of the key layout opposite the first direction to a second vertical end of the key layout opposite the first vertical end. The shifting may be graphically animated.

The key layout may include an odd number of rows of keys and an odd number of columns of keys, and the active position at the first location may be positioned along a central column of keys and a central row of keys. Displaying the active position may include highlighting the central column of keys and the central row of keys. The highlighting may include increasing a font size of the central column of keys and the central row of keys. The highlighting may include one of: fading, blurring, and dimming parts of the key layout other than the central column and the central row.

While a number of exemplary aspects and examples have been discussed above, those of skill in the art will recognize certain modifications, permutations, additions and sub-combinations thereof.

What is claimed is:

1. A method comprising:
on a display of an electronic device, displaying a key layout, the key layout comprising a plurality of rows of keys and a plurality of columns of keys;
displaying an indication of an active position at a first location of the key layout for selecting one of the keys;
detecting a directional input;
in response to the directional input, adjusting the key layout while maintaining display of the indication of the active position at the first location.

2. The method according to claim 1, further comprising:
detecting a selection input;
in response to the selection input, selecting a function associated with the key at the first location.

3. The method according to claim 2, wherein one of the keys comprises a selectable feature to change the keyboard, and the method further comprises:
in response to the selection input, when the key comprising the selectable feature is at the first location, changing the keys of the key layout from a first key set to a second key set.

4. The method according to claim 3, wherein the first and second key sets comprise keys associated with character sets selected from one of: upper case letters, lower case letters, numbers, letters of other languages, and emoticons.

5. The method according to claim 1, wherein the directional input comprises one of: an up input, a down input, a left input, a right input, an up-right input, an up-left input, a down-right input and a down-left input.

6. The method according to claim 1, wherein the directional input comprises a first direction and adjusting the key layout comprises:
shifting the key layout in a direction opposite the first direction wherein the location of the keys are changed by at least one position in a direction opposite the first direction.

7. The method according to claim 6, wherein the shifting further comprises:
when the first direction comprises a horizontal direction, moving the location of keys at a first horizontal end of the key layout opposite the first direction to a second horizontal end of the key layout opposite the first horizontal end, and
when the first direction comprises a vertical direction, moving the location of a row of keys at a first vertical end of the key layout opposite the first direction to a second vertical end of the key layout opposite the first vertical end.

8. The method according to claim 7, wherein the shifting comprises graphically animating the shifting of the key layout.

9. The method according to claim 1, wherein the key layout comprises an odd number of rows of keys and an odd number of columns of keys, and wherein the active position at the first location is at an intersection of a central column of keys and a central row of keys.

10. The method of claim 9 wherein displaying the indication of the active position comprises highlighting the central column of keys and the central row of keys.

11. The method according to claim 10, wherein the highlighting comprises increasing a font size of the central column of keys and the central row of keys.

12. The method according to claim 10, wherein the highlighting comprises one of: fading, blurring, and dimming a part of the key layout other than the central column and the central row.

13. A computer-readable medium having computer-readable instructions executable by at least one processor of an electronic device to perform the method according to claim 1.

14. An electronic device comprising:
a display for producing an image;
a user interface for receiving inputs;
at least one processor coupled to the display and the user interface and configured to, on the display of the electronic device, display a key layout, the key layout comprising a plurality of rows of keys and a plurality of columns of keys, display an indication of an active position at a first location for selecting one of the keys, detect a directional input, and in response to the directional input, adjust the key layout while maintaining display of the indication of the active position at the first location.

15. An electronic device according to claim 14 comprising a frame configured to be mounted on a head of a user, wherein the display is coupled to the frame, and wherein the user interface comprises a sensor unit coupled to the frame, the sensor unit comprising one or more motion sensors connected to provide motion signals to the processor.
